(19) United States
(12) Patent Application Publication
(10) Pub. No.: US 2010/0082675 A1
(43) Pub. Date: Apr. 1, 2010

(54) METHOD AND APPARATUS FOR ENABLING WIDE AREA GLOBAL NAME SPACE

(75) Inventor: Hidehisa SHITOMI, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD, Tokyo (JP)

(21) Appl. No.: 12/242,297

(22) Filed: Sep. 30, 2008

(51) Int. Cl. G06F 17/30

(52) U.S. Cl. 707/782; 707/E17.032

(57) ABSTRACT

Described are methods and apparatus for establishing a wide area GNS. The key points for implementing the wide area GNS are GNS information sharing among sites and maintaining cache consistency. In a system having the wide area GNS functionality, NFS clients may need to gain access to remote file systems, which may result in prolonged delays. Even worse, network file system protocol may not be able to penetrate firewalls. To solve these problems a cache technology is applied. Once cache mechanism is deployed, cache consistency control is implemented. More specifically, the situation when the NFS client opens a cached file at a remote site, and NFS client would like to write data to an original file.

1. Field of the Invention

This invention generally relates to storage systems, and more specifically to the Network Attached Storage (NAS).

2. Description of the Related Art

The Global Name Space (GNS) is a functionality that integrates multiple file systems provided by NASs into one single name space, and provides the name space to NAS clients. By utilizing GNS, system administrators can migrate a file system from a NAS node to another NAS node without client disruptions, which means clients do not know the migration and do not have to change the mount point. The migration occurs due to the capacity management, load balancing, NAS replacement, and data life cycle management.

There are various existing implementations for GNS, including in-band pNFS system and out-band file virtualization products available from Acopia Networks, well known to persons of ordinary skill in the art. The aforesaid pNFS is a Parallel Network File System (pNFS), which is an extension to NFS v4 that allows clients to access storage devices directly and in parallel thus eliminating the scalability and performance issues associated with NFS servers in deployment today. This is achieved by the separation of data and metadata, and moving the metadata server out of the data path. File virtualization products available from Acopia Networks also include the aforesaid GNS functionality. However, in the aforesaid conventions systems, GNS is utilized only within a single site.

Applications for site-wide collaborative work such as for design data sharing and program sharing are popular in certain industries such as manufacturing. In the aforesaid collaborative work applications, files are shared among related sites. File transfer is one of the popular solutions for enabling the collaborative work between different sites. However, when the file transfer is used for collaboration, the name space of the files varies in each site. Consequently, the application programs using the files should be specially configured for each site. Moreover, when designers or programmers move to the other site, the name space configurations should be changed according to the site configuration specifics.

Therefore, the conventional technology fails to provide a solution for establishing a global name space for purposes of storing data in a wide area network configuration.

### SUMMARY OF THE INVENTION

The inventive methodology is directed to methods and systems that substantially obviate one or more of the above and other problems associated with conventional techniques for implementing GNS across multiple NAS storage systems.

In accordance with one aspect of the inventive concept, there is provided a system including a network attached storage configured to perform at least one file access operation in accordance with a received access request. The aforesaid network attached storage is located in a first site and incorporates a storage system configured to store a target file. The system further includes a global name space server located in the first site and configured to receive a client file access request from a network attached storage client. The received client file access request is accompanied by a global file location information indicative of a location of the target file in a global name space. The global name space server is further configured to translate the global file location information to a local file location information indicative of the location of the target file within the network attached storage of the first site, and also configured to use the local file location information to enable the network attached storage client to access the target file. The global name space server incorporates a global name space management module configured to receive a registration request associated with the network attached storage, to register network attached storage information with the global name space server, to communicate the network attached storage information and site identification information to a second global name space management module executing on a second global name space server located on a second site, remote from the first site, and to cause the second global name space management module to register the network attached storage information and site identification information with the second global name space server of the second site. In the above system, the second site is connected to a first site through a wide area network.

In accordance with another aspect of the inventive concept, there is provided a method performed in a system including a network attached storage configured to perform at least one file access operation in accordance with a received access request, the network attached storage being located in a first site and includes a storage system configured to store a target file. The system further includes a global name space server located in the first site, which includes a global name space management module. The inventive method involves: receiving, by the global name space server, a client file access request from a network attached storage client, the client file access request being accompanied by a global file location information indicative of a location of the target file in a global name space; translating the global file location information to a local file location information indicative of the location of the target file within the network attached storage of the first site; using the local file location information to enable the network attached storage client to access the target file; receiving, by a global name space management module, a registration request associated with the network attached storage; registering network attached storage information with the global name space server; communicating the network attached storage information and site identification information to a second global name space management module executing on a second global name space server located on a second site, remote from the first site; and causing the second global name space management module to register the network attached storage information and site identification information with the second global name space server of the second site, wherein the second site is connected to a first site through a wide area network.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a hardware configuration in which the method and apparatus of this invention can be applied.

FIG. 2 illustrates an exemplary embodiment of a software configuration in which the method and apparatus of this invention can be applied.

FIG. 3 represents a conceptual diagram of file access through GNS.

FIG. 4 shows a conceptual diagram of wide area GNS setup (e.g. initial setup or configuration changes).

FIG. 5 illustrates exemplary embodiments of a GNS Management Tables for two sites.

FIG. 6 illustrates an exemplary embodiment of a control procedure for wide area GNS setup.

FIG. 7 shows a conceptual diagram of cache creation operation.

FIG. 8 illustrates other exemplary embodiments of a GNS Management Tables for two sites.

FIG. 9 illustrates an embodiment of a control procedure for cache creation.

FIG. 10 illustrates an exemplary conceptual diagram of cache consistency control mechanism.

FIG. 11 illustrates an exemplary embodiment of control procedure of cache consistency control.

FIG. 12 illustrates another exemplary conceptual diagram of cache consistency control mechanism.

FIG. 13 illustrates another exemplary embodiment of control procedure for cache consistency control.

FIG. 14 illustrates an exemplary conceptual diagram of site configuration change operation.

FIG. 15 illustrates exemplary embodiment of updated GNS Management Tables for two sites.

FIG. 16 illustrates an exemplary embodiment of a control procedure for site configuration change operation.

FIG. 17 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### 1. First Embodiment

### 1.1 System Configurations

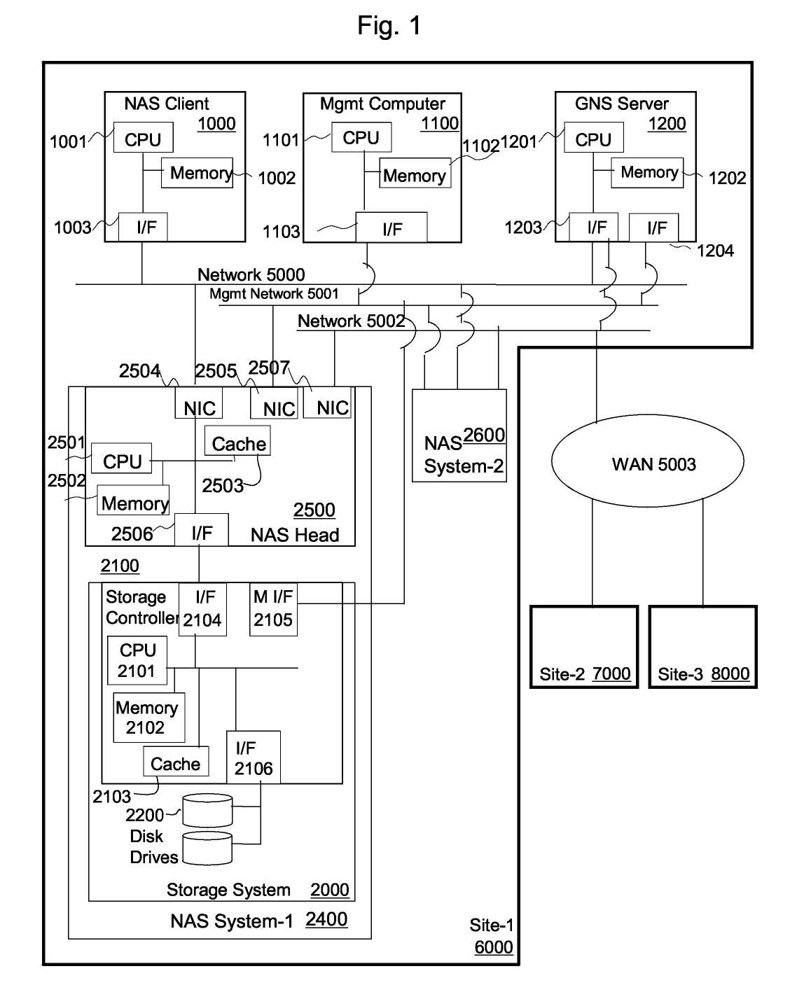

FIG. 1 illustrates an exemplary embodiment of a hardware configuration in which the method and apparatus of this invention can be applied. The system is composed of multiple sites 6000, 7000, and 8000. The sites are connected through Wide Area Network 5003. In each site, NAS Clients 1000, Management Computer 1100, GNS server 1200, and NAS Systems 2400, 2600 are located.

NAS Clients 1000: Application and NFS (Network File System) client software which are not shown in FIG. 1 are running on a CPU 1001. The NAS clients equipped with the Network Interface (I/F) 1003 are connected to GNS server 1200, NAS Systems 2400, and 2600 via Network 5000.

Management Computer 1100: A Management Software which is not shown in FIG. 1 is running on a CPU 1001. The Management Computer equipped with network interface (I/F) 1103 is connected to the NAS Head 2500, Storage Systems 2000, and GNS server 1200 via Network 5001.

GNS server 1200: A GNS Management Program, which is not shown in FIG. 1 is running on a CPU 1201. The GNS server 1200 equipped with network interface (I/F) 1203 is connected to the NAS client 1000, NAS system 2400, and 2600 via the Network 5000. In addition it is connected to other sites 7000 and 8000 via the Network 5002. Moreover, by means of the interface 1204, the GNS Server 1200 is connected to the Management Computer 1100 via Network 5001. The network interfaces 1203 and 1204 can be either physically separated or implemented using the same hardware. In another implementation, the GNS server can be implemented within the NAS Head 2500. In this case, the additional hardware for deploying the GNS Server is not required.

Networks 5000, 5001, and 5002: These networks can be implemented as either physically separate networks or logically separate networks by utilizing, for example, a network partitioning technology such as VLAN. The typical network media, which can be used in implementing these networks, is Ethernet.

NAS Systems 2400 and 2600: The systems incorporate two main components: NAS Head 2500 and Storage System 2000. The storage system 2000 consists of a Storage Controller 2100 and Disk Drives 2200. NAS Head 2500 and storage system 2000 can be interconnected via interfaces 2506 and 2104. NAS Head 2500 and storage system 2000 can be deployed in the same storage unit, called Filer. In this case, the aforesaid two components can be connected via a system bus such as PCI-X. Moreover, the NAS head can include internal disk drives without having to use any storage controller. Such configuration is quite similar to the configuration of a general purpose server. On the other hand, in another embodiment, the NAS Head and controller can be physically separated. In this case, the two components are interconnected via network connections such as Fibre Channel or Ethernet. Although there are various possible hardware implementations, the present invention is not limited to any specific implementation.

The NAS Head 2500 comprises CPU 2501, memory 2502, cache 2503, frontend network interface (NIC) 2504, management network interface (NIC) 2505, disk interface (I/F)2506, and network interface for external sites (NIC) 2507. The NICs 2504, 2505, and 2507 can be either physically separate or logically separate. The NAS Head 2500 processes requests from the NAS clients 1000, Management Host 1100, and GNS server 1200.

CPU 2501 and memory 2502: The program for processing NFS requests or other operations is stored in the memory 2502 and is executed by the CPU 2501.

Cache 2503: The Cache temporally stores NFS write data from the NFS clients 1000 before the data is forwarded to the storage system 2000. In addition, the Cache can store NFS read data that is requested by the NFS clients 1000. It may be implemented as a battery backed-up non-volatile memory. In another implementation, the memory 2502 and the cache memory 2503 are combined with the same memory device.

Frontend network interface 2504: It is used to establish a connection between NAS clients 1000, GNS server 1200 and NAS Head 2500. Ethernet is a typical example of interconnect, which can be used for this purpose.

Management network interface 2505: It is used to establish a connection between management computer 1100 and NAS Head 2500. The Ethernet is a typical example of interconnect, which can be used for this purpose.

Disk interface 2506: It is used to establish a connection between NAS head 2500 and storage system 2000. The Fibre Channel (FC) and Ethernet are typical examples of interconnect, which can be used for this purpose. In case of internally implemented connection between NAS head and controller (i.e. single storage unit implementation), system bus is a typical example of interconnect, which can be used for this purpose.

Network interface for external sites 2507: It is used to establish a connection between NAS Head 2500 at a site and NAS Heads at the other sites. The Ethernet is a typical example of interconnect, which can be used for this purpose.

The storage controller 2100 comprises CPU 2101, memory 2102, cache memory 2103, frontend interface 2104, management interface (M I/F), and disk interface (I/F) 2106. The storage controller2100 processes I/O requests from the NAS Head 2500.

CPU 2101 and memory 2102: The program for processing I/O requests and/or other operations is stored in the memory 2102, and is executed by the CPU 2101.

Cache memory 2103: The Cache 2103 temporally stores the write data from the NAS Head 2500 before the data is stored in the disk drives 2200. Additionally, it can store the read data that is requested by the NAS Head 2500. The Cache 2103 may be implemented as a battery backed-up non-volatile memory device. In another implementation, the memory 2102 and the cache memory 2103 are combined within the same memory device.

Host interface 2104: The Host interface 2104 is used to establish connection between the NAS Head 2500 and the storage controller 2000. The Fibre Channel (FC) and Ethernet are typical examples of interconnect that can be used for this purpose. In addition, a system bus connection such as PCI-X can be used for this purpose as well.

Management interface (M I/F) 2105: The Management interface (M I/F) 2105 is used to establish connection between the Management Computer 1100 and the storage controller 2000. The Ethernet is a typical example of interconnect that can be used for this purpose.

Disk interface (I/F) 2106: It is used to establish connection between disk drives 2200 and the storage controller 2000.

Disk Drives 2200: Each of the disk devices 2200 processes the I/O requests in accordance with disk device commands, which can be SCSI commands, and performs operations specified by those commands.

As would be appreciated by those of skill in the art, other appropriate hardware architectures used in the inventive system as well. Therefore, the invention is not limited to any specific hardware architecture.

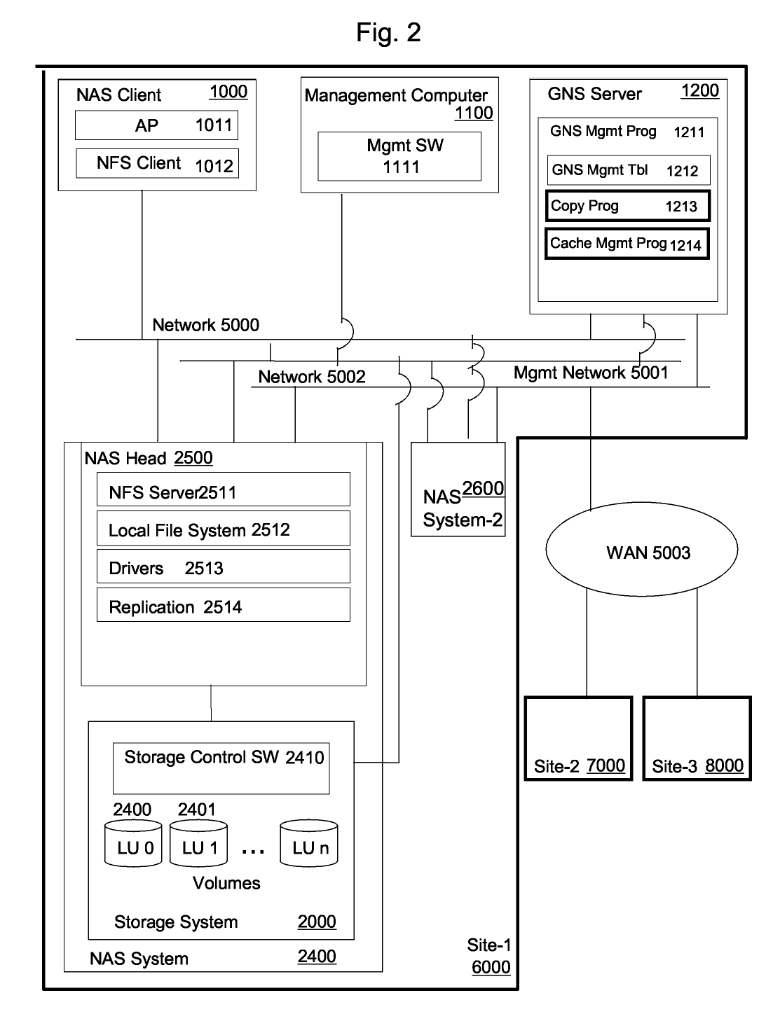

FIG. 2 illustrates an exemplary embodiment of a software configuration in which the method and apparatus of this invention can be applied. The system shown in FIG. 2 is composed of multiple sites. Each site houses NAS Clients 1000, Management Computer 1100, GNS server 1200, and NAS Systems 2400 and 2600.

NAS Clients 1000: NAS client 1000 is a computer executing a software application (AP) 1011, which generates various file manipulating operations. A Network File System (NFS) client program is also located on the NAS client node 1000. In one embodiment of the invention, both out-band and in-band GNS method implementations are applied. For out-band method, the special NFS client program such as pNFS or some other proprietary client program is deployed. The NFS client program communicates with the NFS server program on the GNS server and the NAS Systems 2400 using a network protocol such as TCP/IP. For in-band method, the conventional NFS client program such as NFS v2, 3, 4 and CIFS communicate with the NFS server program having GNS functionality deployed on the NAS Systems 2400 through network protocols such as TCP/IP. The NFS clients, GNS server, and NAS systems are interconnected via a network 5000, which can be a local area network (LAN).

Management Host 1100: The Management software 1111 is stored on the Management Computer 1100. Various NAS management operations such as system configuration settings can be initiated from the management software 1111.

GNS server 1200: GNS Management Program 1211 provides GNS functionality to the NAS clients 1000. GNS Management Table 1212 maintains attributes of file systems or files, which may include location information. For the out-band method, the GNS Management Program receives an NFS request from the NFS client 1012, and, in response to the received request, returns certain attributes of the file, designed in the NFS request, to the NFS client. For in-band method, the GNS Management Program receives an NFS request from the NFS client 1012, and then resolves the location of the designated file, and forwards the request to the designated location. In an embodiment of the invention, the GNS Management information should be shared among sites. To this end, a Copy Program 1213 executed by the GNS Server 1200 communicates with another Copy Programs on the other sites, and exchanges the content of the GNS Management Table 1212 with such other Copy Programs. Moreover, because the sites can be geographically separated, a long delay in the communication can occur. Therefore, an embodiment of the invention incorporates a cache mechanism, which is used to alleviate the communication delay resulting from the geographical separation of the sites. The consistency of the cached data is managed by the Cache Management Program 1214.

NAS Systems 2400 and 2600: These systems consist of two principal parts: NAS Head 2500 and Storage System 2000.

NAS Head 2500: NAS Head 2500 is a part of a NAS system 2400. This module processes all operations directed to the NAS system.

The NFS server program 2511 communicates with the NFS client 1012 on the NAS clients 1000, and processes NFS operations directed to the file systems managed by NAS System 2400. It also communicates with the GNS Management Program 1211 in order to manage the file attributes.

The local file system 2512 processes file I/O operations directed to the file systems on the storage system 2000.

Drivers 2513 of storage system translate the file I/O operations received by the NAS Head 2500 into the block level operations, and communicate with the storage controller 2000 using SCSI commands.

Replication program 2514 replicates file systems or files from the local storage 2000 to another remote storage.

Storage System 2000: A storage control software 2410 processes SCSI commands received by the Storage System 2000 from the NAS head 2400. Logical Volumes (LU) 2400 and 2401 are composed of one or more disk drives 2200. The file systems for storing data are created in volumes 2400 or 2401.

### 1.2 Global Name Space (GNS)

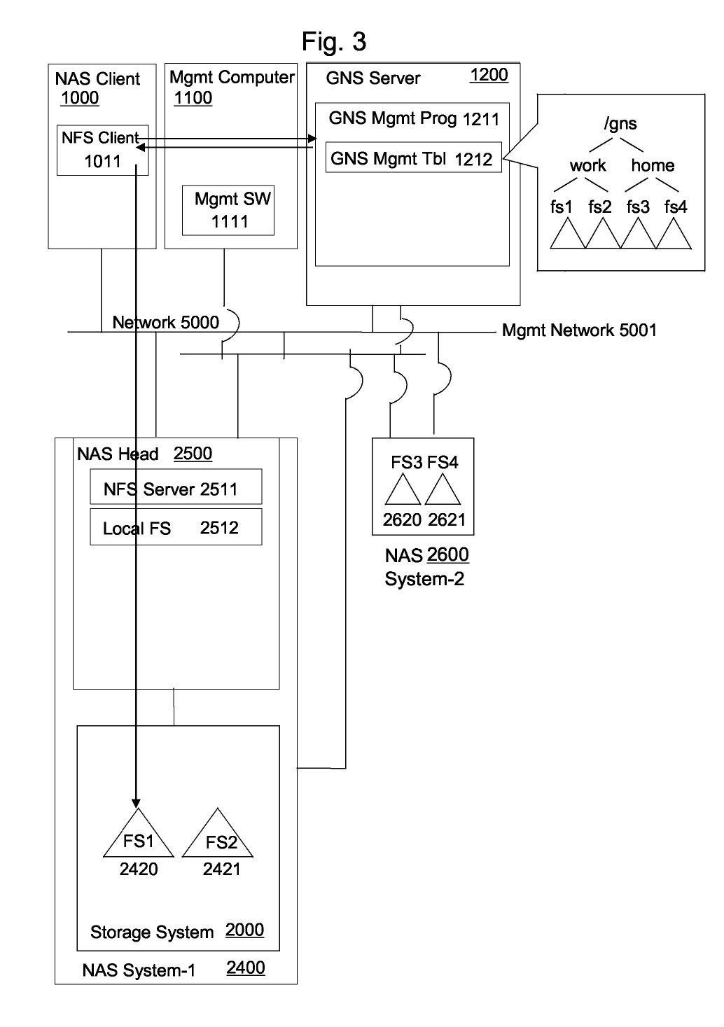

FIG. 3 represents a conceptual diagram of file access procedure through GNS.

An administrator registers file system information (e.g. NAS IP address, export name, and the like) into the GNS Management Table 1212 via the GUI/CLI of the Management Software 1111 or the GNS Management Program 1211. In FIG. 3, the file systems FS1 2420 and FS2 2421 on the NAS1 2400, and FS3 2620 and FS4 2621 on the NAS2 2600 all participate in the GNS. When NAS Clients mount the GNS mount point such as /gns, they can see the GNS file system tree.

In the out-band method, the NAS client 1000 accesses the GNS server 1200, and the GNS server 1200 returns the designated file location to the NAS client 1000. After that, the NAS client 1000 accesses the designated file on the NAS 2400 using the file location information received from the GNS server 1200. In in-band method, the NAS client 1000 accesses the GNS server 1200. The GNS server resolves the designated file location, and proceeds to forward the request to the NAS 2400.

As would be appreciated by those of skill in the art, the present invention is not limited to any one specific method. In the following explanation, the out-band method are employed for illustration only.

### 1.3 Wide Area GNS

As stated above, applications for site-wide collaborative work such as for design data sharing and program sharing are popular in certain industries such as manufacturing. In the aforesaid collaborative work applications, files are shared among related sites. File transfer is one of the popular solutions for enabling the collaborative work between different sites. However, when the file transfer is used for collaboration, the name space of the files varies in each site. Consequently, the application programs using the files should be specially configured for each site. Moreover, when designers or programmers move to the other site, the name space configurations should be changed according to the site configuration specifics.

To solve these problems, an embodiment of the inventive concept provides common name space for several different sites. To this end, the GNS technology described above is extended and applied to wide area networks. The key elements necessary for such extension of the GNS are GNS information sharing among different sites and methods for maintaining cache consistency.

### 1.3.1 Wide Area GNS Setup Phase

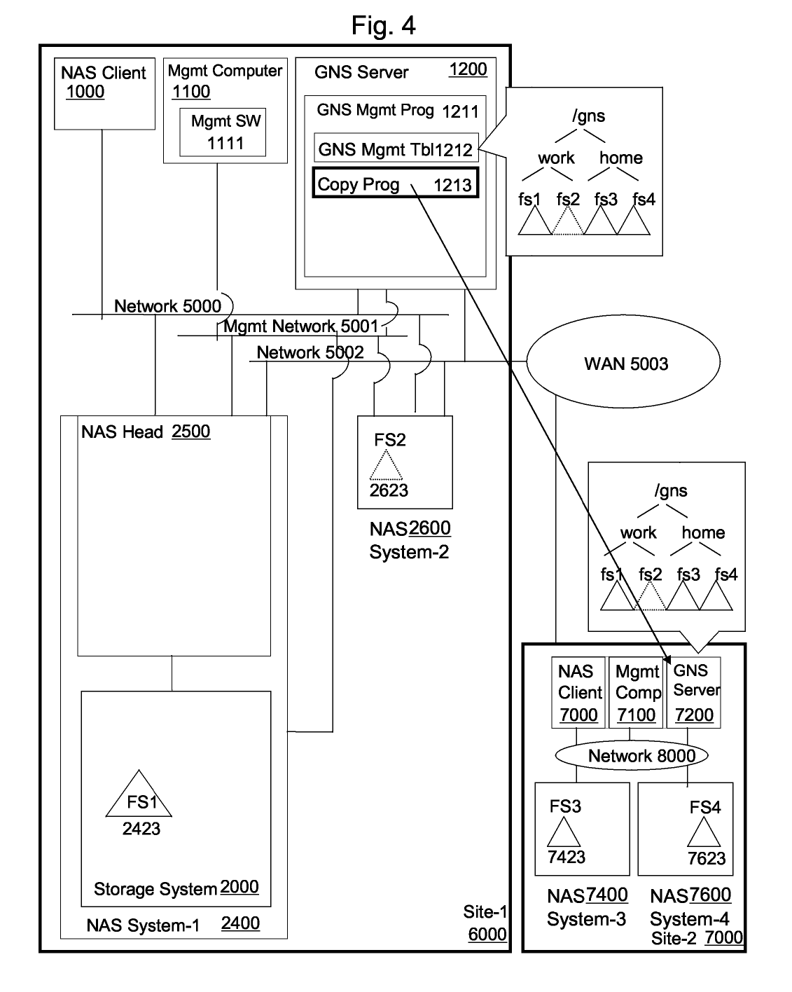

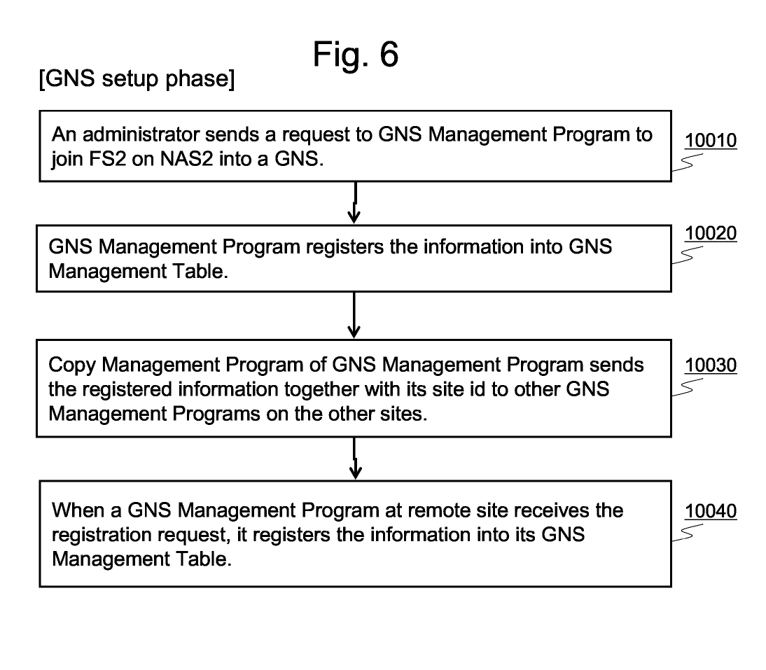

FIG. 4 illustrates an exemplary conceptual diagram of a wide area GNS setup (e.g. initial setup or configuration changes). FIG. 6 represents an example of control procedure for wide area GNS setup. In FIG. 4, the FS1 2423 on NAS1 2000 at site1 6000, FS3 7423 on NAS3 7400 and FS4 7623 on NAS4 7600 at site2 7000 have already joined the GNS. The FS2 2623 on NAS2 2600 at site1 6000 is in the process of joining to the GNS.

Upon the setup of the wide area GNS, an administrator should define a Site Group within which the GNS information is shared by the GNS Management Programs of different sites, and register the Site Group with the GNS Management Program.

An administrator sends a request for joining FS2 on NAS2 into the GNS to the GNS by means of a graphical user interface (GUI), command line interface (CLI), Management Software 1111 or GNS Management Program 1211. Upon registration, the information such as GNS path name, node name (or IP address), and local path name are provided. (Step 10010)

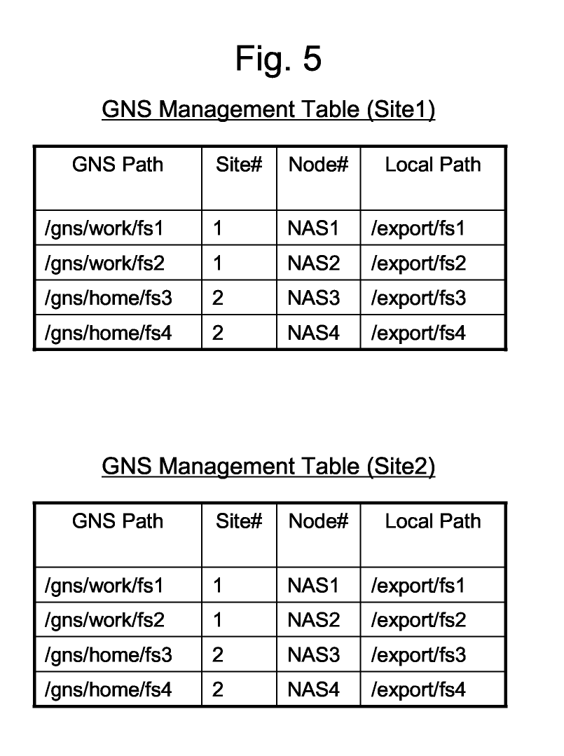

GNS Management Program 1211 registers the received information into the GNS Management Table 1212 (Step 10020). An exemplary embodiment of the GNS Management Table is shown in FIG. 5.

Copy Management Program 1213 executing under the GNS Management Program 1211 sends the information registered in the GNS Management Table 1212, together with its site id to the other GNS Management Programs on the other sites. (Step 10030)

When the GNS Management Program at remote site receives the registration request and accompanying information, it registers the received information into its GNS Management Table. (Step 10040)

After finishing all GNS Management Table updates, the GNS Management Program publishes the new namespace to NAS clients.

### 1.3.2 Cache

Due to the use of the above-described wide area GNS, NFS clients may need to gain access to remote file systems. In such cases, long communication delays can occur due to the distance to the remote site. In even worse scenario, network file system protocol may not penetrate through a firewall. To solve these problems, an embodiment of the inventive system incorporates cache technology.

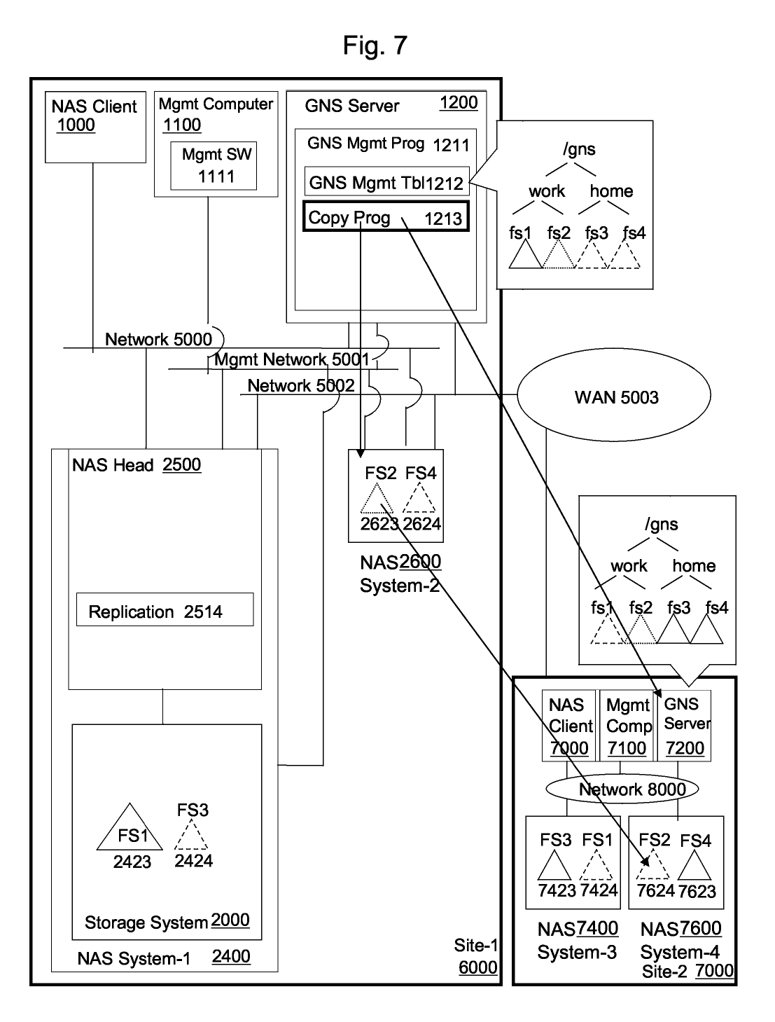

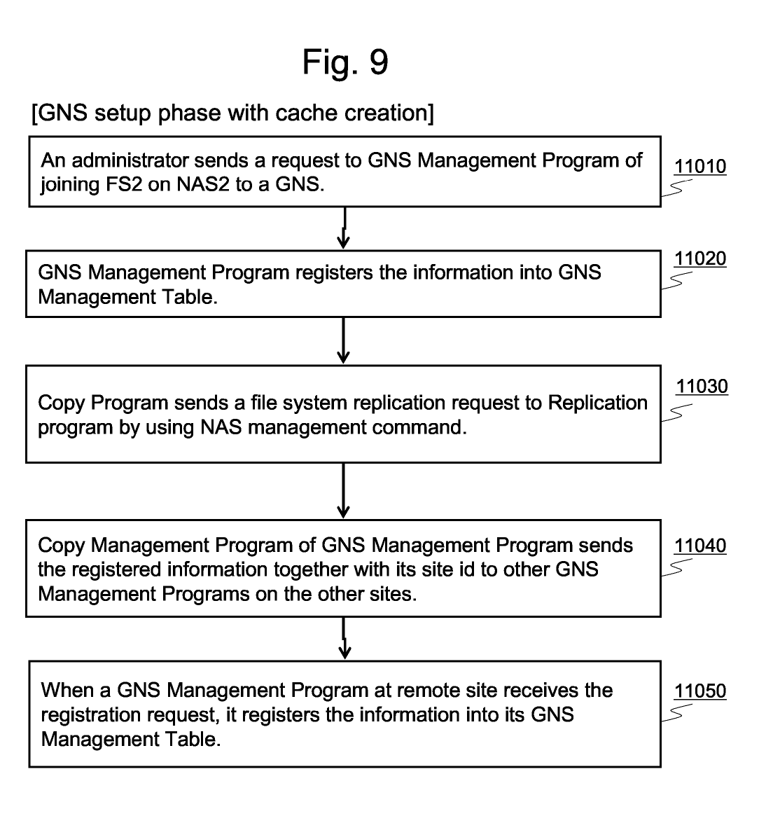

FIG. 7 illustrates a conceptual diagram of cache creation operation. On the other hand, FIG. 9 represents an exemplary embodiment of a control procedure for cache creation based on the configuration of FIG. 7. In the following explanation, the same system configuration as was used in the previous section is employed. The cache creation operation is performed when the FS2 is joined into the GNS.

In the procedure shown in FIG. 9, the step 11010 is the same as the step 10010 of the procedure shown in FIG. 6.

Step 11020 is the same as step 10020.

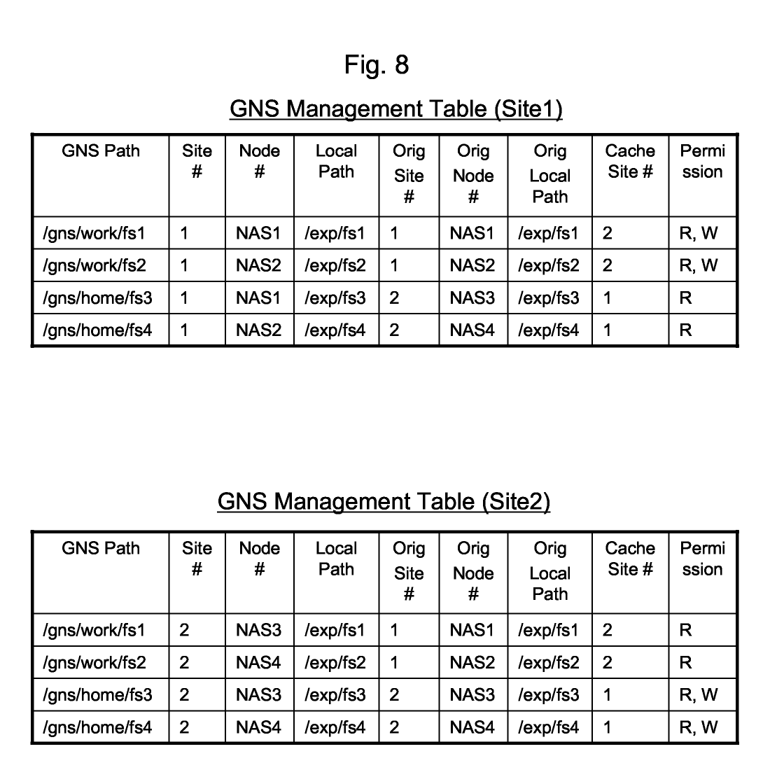

In step 11030, the Copy Program 1213 sends a file system replication request to Replication program 2514. This is accomplished by using a NAS management command. At the request, the replication target NASs and sites should be designated. As for target sites, all but the original site can be one option. In this case, other sites can be found in the predetermined Site Group. And, an administrator can specify cached sites, when a file system is joined to the GNS at Step 10010. The specified site information can be stored in a column of GNS Management Table 1212 such as Cache Site #. As for target NASs, an administrator can be specified. Or, GNS Management Programs can negotiate at replication. In this case, the target side GNS Management program may find a NAS which has most unused capacity, and it notifies the NAS node id or IP address to the source side GNS Management Program. In FIG. 7, FS2 on NAS2 is replicated to FS2 on NAS4. GNS Management Program updates GNS ManagementTable according to the replication, as shown in FIG. 8. When file system is provided by the local site, the permission column should be read and write mountable. When file system is provided by the remote site, and the cache is utilized, the permission column should be read mountable.

The step 11040 is the same as step 10030.

The step 11050 is the same as step 10040.

After finishing all GNS Management Table updates, the GNS Management Program publishes the new namespace to NAS clients.

Any replication methods. (e.g. synchronous, asynchronous, push (push data from source to target), pull (pull data from source)) can be utilized in the replication feature of the present invention. Therefore, the present invention is not limited to any specific replication method used.

### 1.3.3 Cache Consistency Control

Once the cache mechanism is deployed, one needs to take care of the cache consistency control. More specifically, one needs to take care of the situation when the NFS client opens a cached file at remote site, and NFS client would like to write data to an original file. In the following example, NAS client 7000 has already opened a file on FS1 7424, which is cached data at site2 7000, and NAS client 1000 tries to write open the same file on FS1 2423 at site1 6000, which is an original file. GNS Management Program maintains the status of each file, and also shares the status among sites. Then, GNS Management Program handles the cache consistency control. Two strategies can be used.

(1) Tight Consistency (strictly single write).

(2) Loose Consistency (allow multiple writes).

For the tight consistency, the following two schemes need to be handled:

(1-1) Deny new write (Original site compromises)

(1-2) Stop cache access (Remote site compromises).

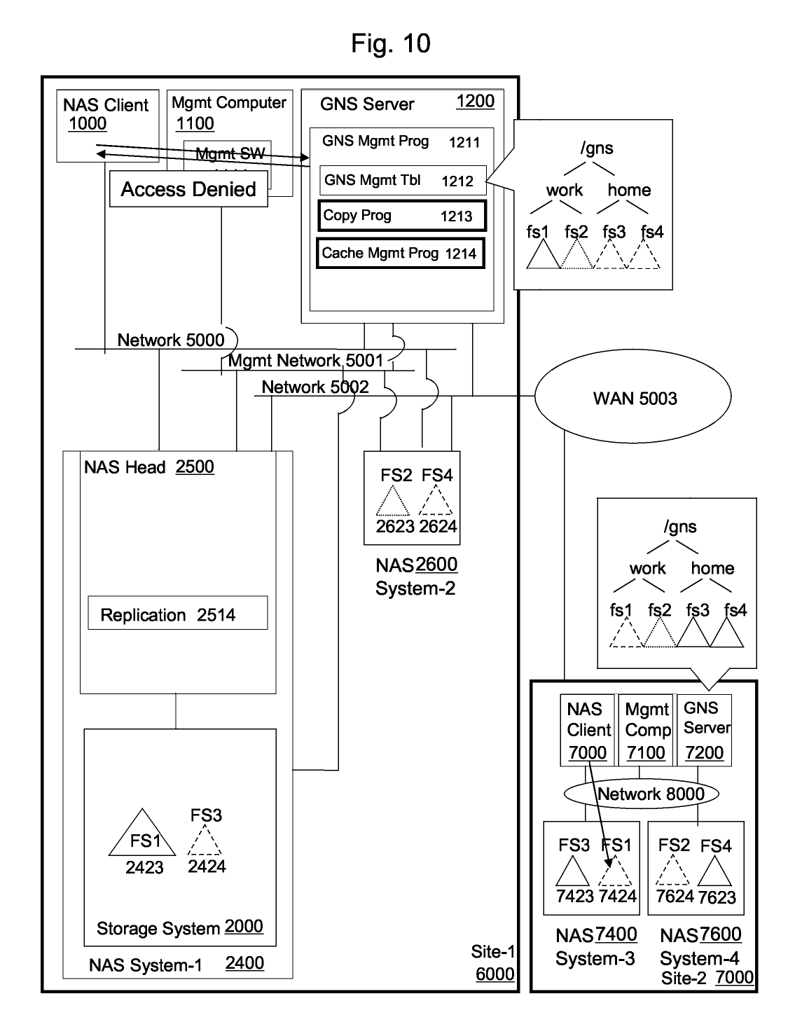

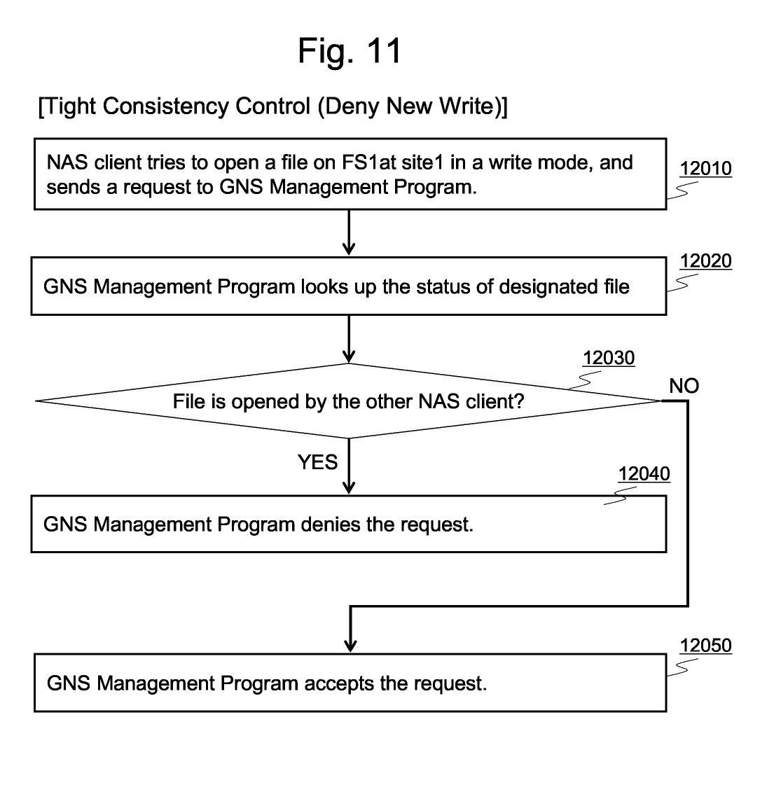

FIG. 10 represents a conceptual diagram of cache consistency control mechanism of (1-1), and FIG. 11 shows an example of control procedure of cache consistency control of (1-1).

NAS client 1000 tries to open a file on FSI 2423 at site1 6000 in a write mode, and sends an appropriate request to the GNS Management Program 1211. (Step 12010).

GNS Management Program looks up the status of designated file (Step 12020), and if the file is opened by the other NAS client, then GNS Management Program denies the request (Step 12040).

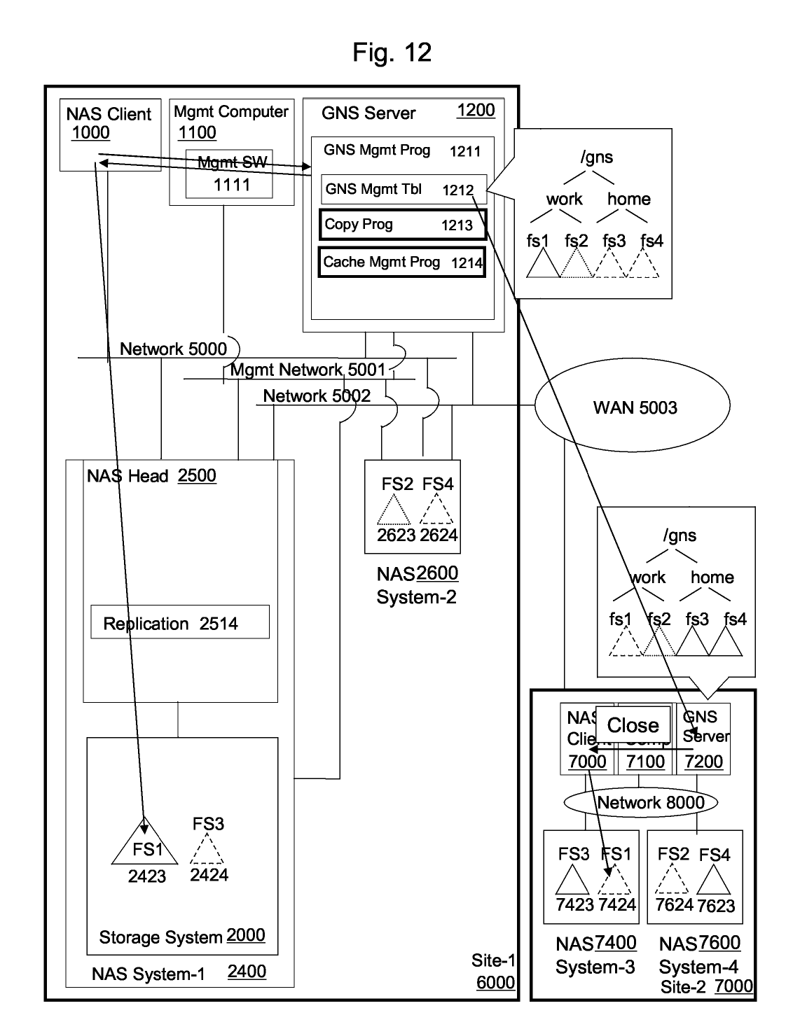

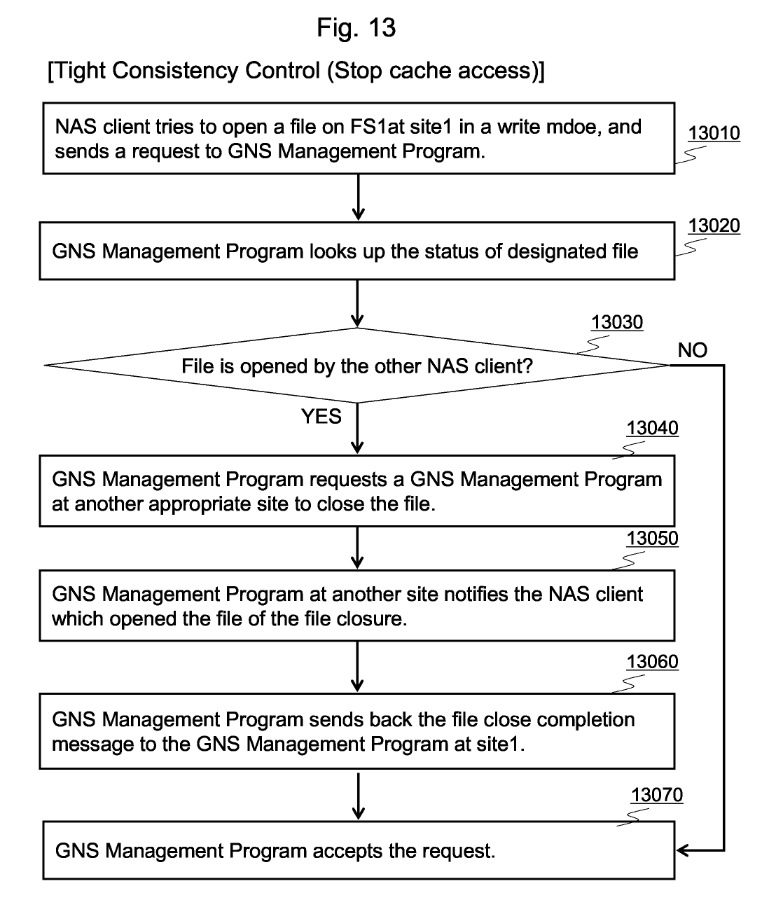

FIG. 12 presents a conceptual diagram of cache consistency control mechanism of (1-2), and FIG. 13 shows an example of control procedure of cache consistency control of (1-2).

NAS client 1000 tries to open a file on FS1 2423 at site1 6000 in a write mode, and sends an appropriate request to GNS Management Program 1211. (Step 13010).

GNS Management Program 1212 looks up the status of designated file (Step 13020), and if the file is opened by the other NAS client 7000, then GNS Management Program 1212 requests closing the file to GNS Management Program at an appropriate site 7000 (Step 13040).

The GNS Management Program at the site 7000 requests the file closure from the NAS client, which opened the file at the site 7000 (Step 13050). GNS Management Program returns the file closure operation completion message to the GNS Management Program 1212 at site1 6000 (Step 13060).

After that, GNS Management Program 1212 accepts the write open request from the NAS client 1000 (Step 13070).

In case when asynchronous remote copy is employed, the timing of the synchronization presents another problem. Two methods can be employed for solving this problem.

When NAS client opens a cached file, the GNS Management Program always checks updates to the file at original site.

If there exists some middleware to manage workflow, and the middleware manages the update to the original file, GNS Management Program communicate with the middleware at the same site by using an API, and gets updates from the original site only when it is needed.

Some enterprises may specify the working time to some file systems. After that, from the specified working schedule, it is possible to assume that no writes come from multiple sites. In this case, the Loose Consistency strategy can be employed.

To implement the loose consistency method, snapshot technology can be utilized. When the write is executed to a cached file, the snapshot is taken and the write operations are applied to the snapshot. At some point (e.g. at the timing of schedule shift), the write operations performed on the snapshot will be applied to the original data.

In an alternative implementation, the GNS Management Program can provide options for an administrator to select the consistency control methods for each file, NAS, or site.

### 1.3.4 Site Configuration Change

The role of each site can be changed through a configuration change process. After that, the GNS configuration should be changed accordingly. In the following example, the roles of site1 and site2 are exchanged.

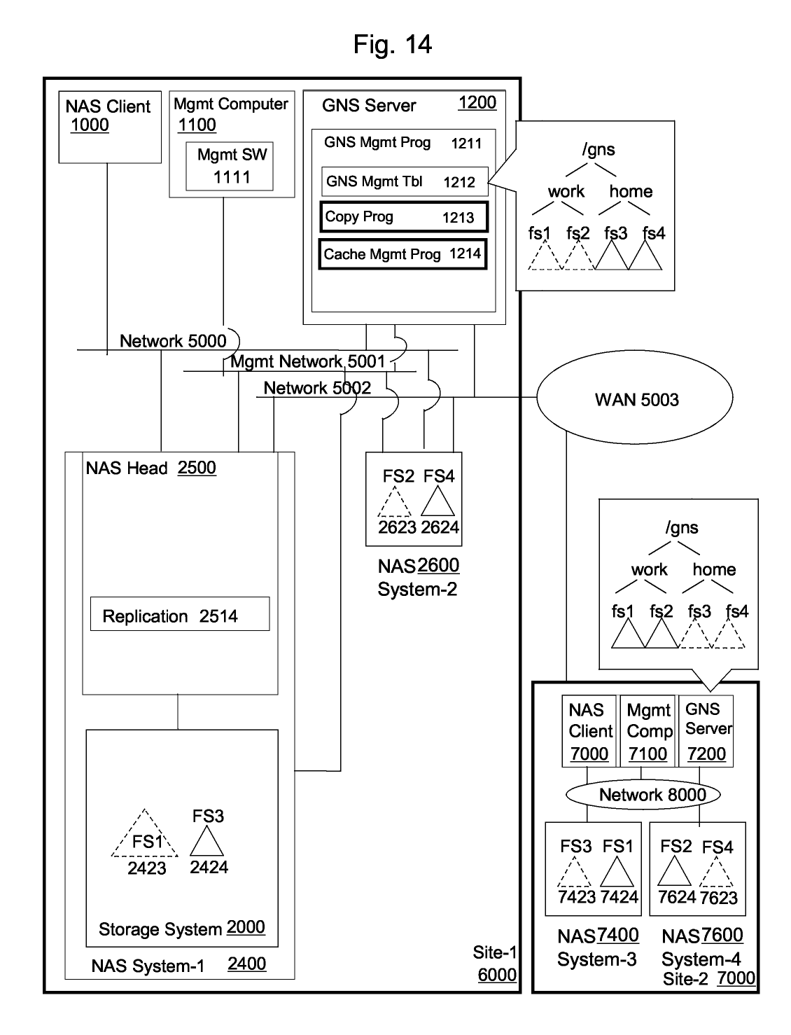

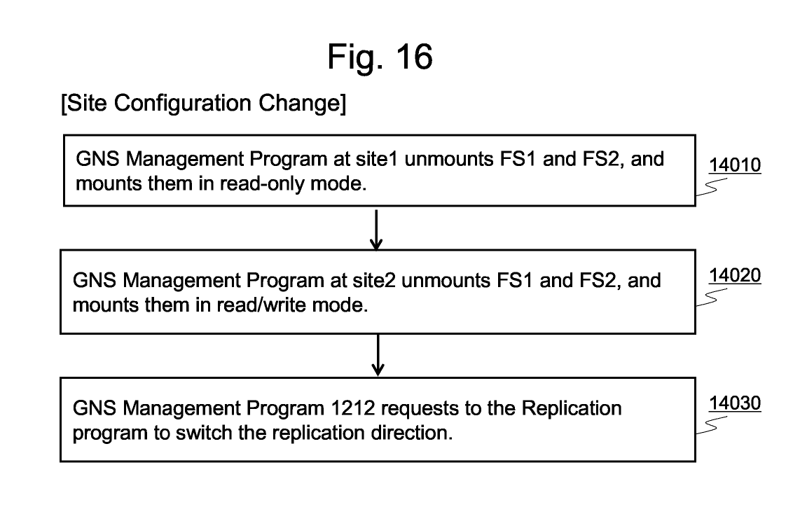

FIG. 14 illustrates an exemplary embodiment of a conceptual diagram of site configuration change operation. FIG. 16 shows an example of control procedure of site configuration change based on the configuration of FIG. 14. An administrator requests the site role change. At site1 6000, the original file systems FS1 2423 and FS2 2623 are changed to become cached file systems. The cached file system FS3 2424 and FS4 2624 are, in turn, changed to become original file systems. At site2 7000, the reversed changes are performed.

GNS Management Program at site1 unmounts FS1 and FS2, and mounts them in read only mode. (Step 14010)

An administrator designates file systems which are changed to be cache file systems via GUI/CLI of Management Software 1111 or GNS Management Program 1211.

GNS Management Program 1212 unmounts the file systems and mounts them in read only mode.

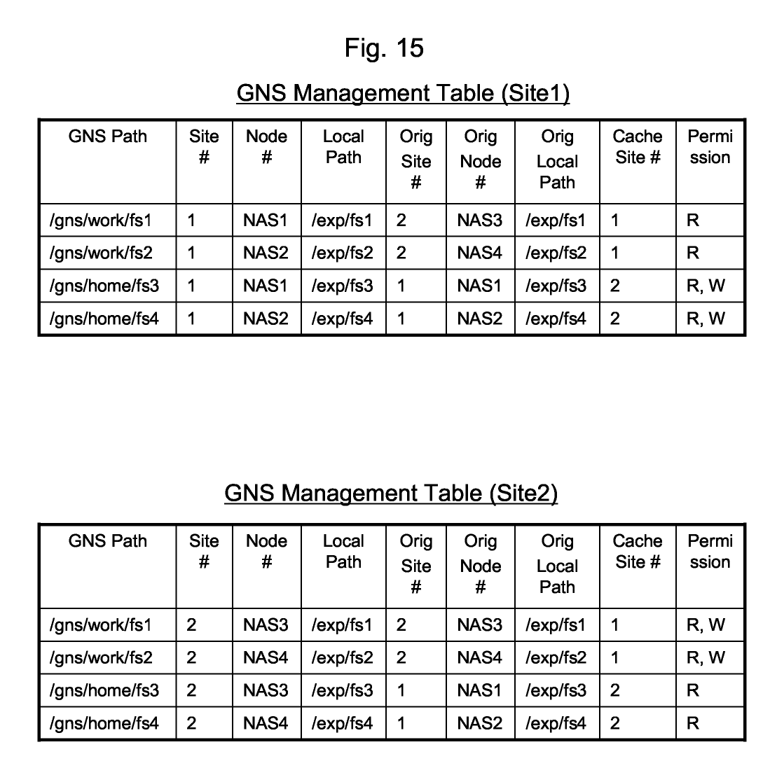

GNS Management Program 1212 updates the information of GNS Management Table 1212. (FIG. 15 site1)

GNS Management Program at site2 unmounts FS1 and FS2, and mounts them in read/write mode. (Step 14020)

An administrator designates a site such as site2 7000 which takes over the master site via GUI/CLI of Management Software 1111 or GNS Management Program 1211.

GNS Management Program 1212 requests a GNS Management Program at the designated site to unmount the file systems and to mount them in read/write mode.

GNS Management Program at the new master site unmounts the file systems and mounts them in read/write mode.

GNS Management Program at the new master site updates the information the GNS Management Table. (FIG. 15 site2)

GNS Management Program 1212 requests to the Replication program to switch the replication direction (from site1→site2 to site2→site1). (Step 14030) As for the FS3 and FS4, the same procedures are performed at site1 and site2.

Also, one needs to take care of the file write during the configuration change. To do that, at the beginning of the configuration change, the GNS Management Program sets a flag indicative of the configuration change in the GNS Management Table. While the flag is set, two methods for handling file write operation can be employed.

In the first method, the GNS Management Program takes snapshots of files or file systems, and accepts write operations directed to them. After finishing the configuration change, the GNS Management Program applied the changes made by the write operations to the original data.

In another implementation, the GNS Management Program denies the write requests.

### 2. Second Embodiment

The GNS can provide not only the global name space resolution functionality, but also perform various other operations. One example is to use the GNS to provide a single data instance detection functionality among file systems under the GNS, which is composed of multiple NAS devices. In such a system, any implementation of the single instance detection algorithm can be employed. In one exemplary embodiment, the GNS Management Program can check the similarity of the newly written data to the existing data using a hash calculation. If the similarity is found, the bit by bit comparison is additionally performed, which verifies that the data is in fact the same. Although the invention is focused to the multi site configuration, the aforesaid single instance feature can be used not only in multi site configuration but also in a single site configuration.

### 3. Exemplary Computer Platform

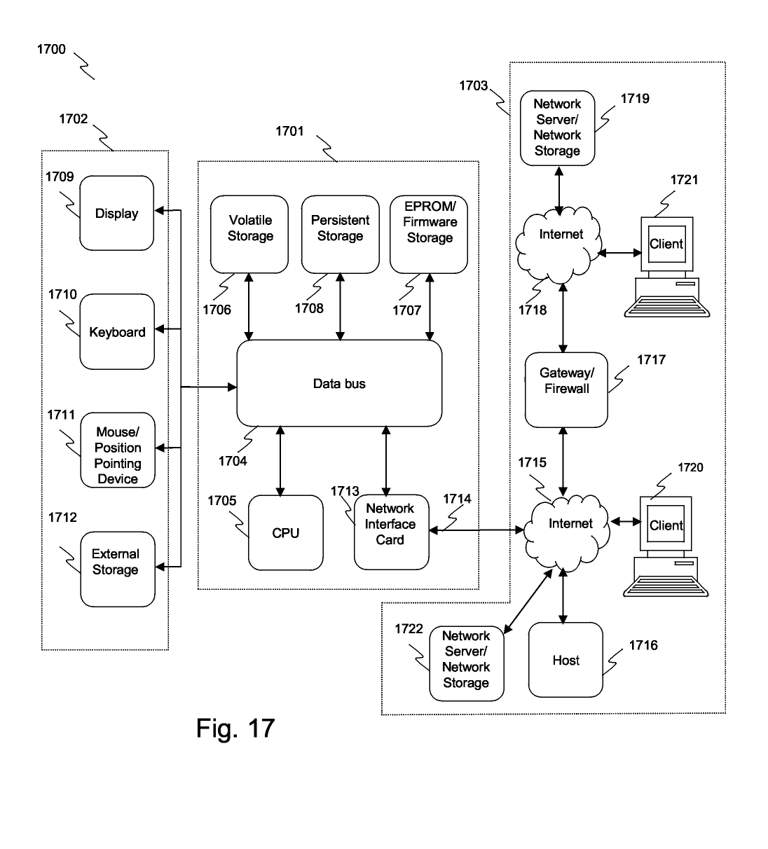

FIG. 17 is a block diagram that illustrates an embodiment of a computer/server system 1700 upon which an embodiment of the inventive methodology may be implemented. The system 1700 includes a computer/server platform 1701, peripheral devices 1702 and network resources 1703.

The computer platform 1701 may include a data bus 1704 or other communication mechanism for communicating information across and among various parts of the computer platform 1701, and a processor 1705 coupled with bus 1701 for processing information and performing other computational and control tasks. Computer platform 1701 also includes a volatile storage 1706, such as a random access memory (RAM) or other dynamic storage device, coupled to bus 1704 for storing various information as well as instructions to be executed by processor 1705. The volatile storage 1706 also may be used for storing temporary variables or other intermediate information during execution of instructions by processor 1705. Computer platform 1701 may further include a read only memory (ROM or EPROM) 1707 or other static storage device coupled to bus 1704 for storing static information and instructions for processor 1705, such as basic input-output system (BIOS), as well as various system configuration parameters. A persistent storage device 1708, such as a magnetic disk, optical disk, or solid-state flash memory device is provided and coupled to bus 1701 for storing information and instructions.

Computer platform 1701 may be coupled via bus 1704to a display 1709, such as a cathode ray tube (CRT), plasma display, or a liquid crystal display (LCD), for displaying information to a system administrator or user of the computer platform 1701. An input device 1710, including alphanumeric and other keys, is coupled to bus 1701 for communicating information and command selections to processor 1705. Another type of user input device is cursor control device 1711, such as a mouse, a trackball, or cursor direction keys for communicating direction information and command selections to processor 1704 and for controlling cursor movement on display 1709. This input device typically has two degrees of freedom in two axes, a first axis (e.g., x) and a second axis (e.g., y), that allows the device to specify positions in a plane.

An external storage device 1712 may be coupled to the computer platform 1701 via bus 1704 to provide an extra or removable storage capacity for the computer platform 1701. In an embodiment of the computer system 1700, the external removable storage device 1712 may be used to facilitate exchange of data with other computer systems.

The invention is related to the use of computer system 1700 for implementing the techniques described herein. In an embodiment, the inventive system may reside on a machine such as computer platform 1701. According to one embodiment of the invention, the techniques described herein are performed by computer system 1700 in response to processor 1705 executing one or more sequences of one or more instructions contained in the volatile memory 1706. Such instructions may be read into volatile memory 1706 from another computer-readable medium, such as persistent storage device 1708. Execution of the sequences of instructions contained in the volatile memory 1706 causes processor 1705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1705 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1708. Volatile media includes dynamic memory, such as volatile storage 1706. Transmission media includes coaxial cables, copper wire and fiber optics, including the wires that comprise data bus 1704. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1705 for execution. For example, the instructions may initially be carried on a magnetic disk from a remote computer. Alternatively, a remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on the data bus 1704. The bus 1704 carries the data to the volatile storage 1706, from which processor 1705 retrieves and executes the instructions. The instructions received by the volatile memory 1706 may optionally be stored on persistent storage device 1708 either before or after execution by processor 1705. The instructions may also be downloaded into the computer platform 1701 via Internet using a variety of network data communication protocols well known in the art.

The computer platform 1701 also includes a communication interface, such as network interface card 1713 coupled to the data bus 1704. Communication interface 1713 provides a two-way data communication coupling to a network link 1714 that is coupled to a local network 1715. For example, communication interface 1713 may be an integrated services digital network (ISDN) card or a modem to provide a data communication connection to a corresponding type of telephone line. As another example, communication interface 1713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1713 sends and receives electrical, electromagnetic or optical signals that carry digital data streams representing various types of information.

Network link 1713 typically provides data communication through one or more networks to other network resources. For example, network link 1714 may provide a connection through local network 1715 to a host computer 1716, or a network storage/server 1717. Additionally or alternatively, the network link 1713 may connect through gateway/firewall 1717 to the wide-area or global network 1718, such as an Internet. Thus, the computer platform 1701 can access network resources located anywhere on the Internet 1718, such as a remote network storage/server 1719. On the other hand, the computer platform 1701 may also be accessed by clients located anywhere on the local area network 1715 and/or the Internet 1718. The network clients 1720 and 1721 may themselves be implemented based on the computer platform similar to the platform 1701.

Local network 1715 and the Internet 1718 both use electrical, electromagnetic or optical signals that carry digital data streams. The signals through the various networks and the signals on network link 1714 and through communication interface 1713, which carry the digital data to and from computer platform 1701, are exemplary forms of carrier waves transporting the information.

Computer platform 1701 can send messages and receive data, including program code, through the variety of network(s) including Internet 1718 and LAN 1715, network link 1714 and communication interface 1713. In the Internet example, when the system 1701 acts as a network server, it might transmit a requested code or data for an application program running on client(s) 1720 and/or 1721 through Internet 1718, gateway/firewall 1717, local area network 1715 and communication interface 1713. Similarly, it may receive code from other network resources.

The received code may be executed by processor 1705 as it is received, and/or stored in persistent or volatile storage devices 1708 and 1706, respectively, or other non-volatile storage for later execution. In this manner, computer system 1701 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems for enabling a wide area GNS. It is intended that the specification and examples be considered as exemplary only, with a true scope and spirit of the invention being indicated by the following claims.

What is claimed is:

1. A system comprising:
a. a network attached storage operable to perform at least one file access operation in accordance with a received access request, the network attached storage being located in a first site and comprising a storage system operable to store a target file; and
b. a global name space server located in the first site and operable to receive a client file access request from a network attached storage client, the client file access request being accompanied by a global file location information indicative of a location of the target file in a global name space, the global name space server further operable to translate the global file location information to a local file location information indicative of the location of the target file within the network attached storage of the first site, and operable to use the local file location information to enable the network attached storage client to access the target file, wherein the global name space server comprises a global name space management module operable to receive a registration request associated with the network attached storage, to register network attached storage information with the global name space server, to communicate the network attached storage information and site identification information to a second global name space management module executing on a second global name space server located on a second site, remote from the first site, and to cause the second global name space management module to register the network attached storage information and site identification information with the second global name space server of the second site, wherein the second site is connected to a first site through a wide area network.

2. The system of claim 1, wherein enabling the network attached storage client to access the target file comprises communicating the local file location information to the network attached storage client.

3. The system of claim 1, wherein enabling the network attached storage client to access the target file comprises forwarding the client file access request to the network attached storage storing the target file.

4. The system of claim 1, wherein the network attached storage comprises a replication module and a file system and wherein upon receipt of the registration request, the global name space management module is further operable to cause the replication program to replicate the file system to a second network attached storage located at the second site.

5. The system of claim 4, wherein upon receipt of the client file access request comprising a write access to the target located in the file system, the global name space management module is operable to:
i. look up a status of the target file;
ii. if the target file is opened by other network attached storage client, deny the client file access request; and
iii. if the target file is not open by other network attached storage client, accept the client file access request.

6. The system of claim 4, wherein upon receipt of the client file access request comprising a write access to the target located in the file system, the global name space management module is operable to:
i. look up a status of the target file;
ii. if the target file is opened by other network attached storage client, request the second global name space management module on the second site to close the target file, receive a confirmation of closure of the target file from the second global name space management module and accept the client file access request; and
iii. if the target file is not open by other network attached storage client, accept the client file access request.

7. The system of claim 1, wherein the global name space server comprises a global namespace management table operable to store the network attached storage information, site identification information, global file location information and local file location information.

8. The system of claim 1, wherein the global namespace management table is further operable to store original network attached storage information, original site identification information, original local file location information, cache site identification information and permission information.

9. The system of claim 1, wherein the global namespace server is operable to detect a single instance of the target file among the network attached storage located in the first site and a second network attached storage located in the second site and to provide a single instance information to the network attached storage client.

10. The system of claim 9, wherein the single instance of the target file is detected using a hash function comparison and a bit by bit comparison.

11. A method performed in a system comprising a network attached storage operable to perform at least one file access operation in accordance with a received access request, the network attached storage being located in a first site and comprising a storage system operable to store a target file; and a global name space server located in the first site, the global name space server comprising a global name space management module, the method comprising:
a. receiving, by the global name space server, a client file access request from a network attached storage client, the client file access request being accompanied by a global file location information indicative of a location of the target file in a global name space;
b. translating the global file location information to a local file location information indicative of the location of the target file within the network attached storage of the first site;
c. using the local file location information to enable the network attached storage client to access the target file;
d. receiving, by a global name space management module, a registration request associated with the network attached storage;
e. registering network attached storage information with the global name space server;
f. communicating the network attached storage information and site identification information to a second global name space management module executing on a second global name space server located on a second site, remote from the first site; and
g. causing the second global name space management module to register the network attached storage information and site identification information with the second global name space server of the second site, wherein the second site is connected to a first site through a wide area network.

12. The method of claim 11, wherein enabling the network attached storage client to access the target file comprises communicating the local file location information to the network attached storage client.

13. The method of claim 11, wherein enabling the network attached storage client to access the target file comprises forwarding the client file access request to the network attached storage storing the target file.

14. The method of claim 11, further comprising, upon receipt of the registration request, replicating the file system to a second network attached storage located at the second site.

15. The method of claim 14, further comprising, upon receipt of the client file access request comprising a write access to the target located in the file system:
i. looking up a status of the target file;
ii. if the target file is opened by other network attached storage client, denying the client file access request; and
iii. if the target file is not open by other network attached storage client, accepting the client file access request.

16. The method of claim 14, further comprising, upon receipt of the client file access request comprising a write access to the target located in the file system:
i. looking up a status of the target file;
ii. if the target file is opened by other network attached storage client, requesting the second global name space management module on the second site to close the target file, receiving a confirmation of closure of the target file from the second global name space management module and accept the client file access request; and
iii. if the target file is not open by other network attached storage client, accepting the client file access request.

17. The method of claim 11, wherein the global name space server comprises a global namespace management table operable to store the network attached storage information, site identification information, global file location information and local file location information.

18. The method of claim 11, wherein the global namespace management table is further operable to store original network attached storage information, original site identification information, original local file location information, cache site identification information and permission information.

19. The method of claim 11, further comprising detecting a single instance of the target file among the network attached storage located in the first site and a second network attached storage located in the second site and providing a single instance information to the network attached storage client.

20. The method of claim 19, wherein the single instance of the target file is detected using a hash function comparison and a bit by bit comparison.
